(19) United States
(12) Patent Application Publication
(10) Pub. No.: US 2025/0236436 A1
(43) Pub. Date: Jul. 24, 2025

(54) REVERSIBLE STACKING MATING INTERFACE

(71) Applicant: Techtronic Cordless GP, Anderson, SC (US)

(72) Inventors: Sage Van Wyk, Greenville, SC (US); Kyle Yeomans, Easley, SC (US); Jeffrey Groves, Greenville, SC (US); Garrett Gerdes, Piedmont, SC (US)

(21) Appl. No.: 19/028,460

(22) Filed: Jan. 17, 2025

Related U.S. Application Data
(60) Provisional application No. 63/622,937, filed on Jan. 19, 2024.
(60) Provisional application No. 63/673,255, filed on Jul. 19, 2024.

(51) Int. Cl. B65D 21/02

(52) U.S. Cl. CPC B65D 21/0224

(57) ABSTRACT

A reversible lockplate and a mating interface for securing a first container relative to a second container in a stacked configuration along a stacking direction are provided. A reversible lockplate includes: a planar body having a plurality of slots configured to receive respective portions of the first container; an articulation mechanism configured to rotate 180 degrees about an articulation axis; and at least one biasing member, the at least one biasing member configured to exert a biasing force on the planar body in a first direction when the reversible lockplate is in a first orientation and in a second direction when the reversible lockplate is in a second orientation. Actuation of the articulation mechanism may cause the reversible lockplate to transition between the first orientation and the second orientation.

### CROSS-REFERENCE TO RELATED APPLICATIONS

The present application claims priority to U.S. Provisional Patent Application No. 63/622,937, filed on Jan. 19, 2024, and U.S. Provisional Patent Application No. 63/673,255, filed on Jul. 19, 2024, the disclosure of each of which is incorporated by reference herein in their entirety.

### FIELD

The present disclosure relates generally to storage containers and, more particularly, to a reversible mating mechanism for storage containers that are securable to one another in a stackable configuration.

### BACKGROUND

Hand tools, power tools, and associated accessories such as light sources, batteries, tool bits, fasteners, and the like, may be moved frequently between a storage space and a workspace. One aspect of accessibility is a user's ability to quickly store an object and remove or relocate the object from storage. Another aspect of accessibility is the storage system's ability to engage many objects with a standardized connection mechanism between the system and the object. This may also permit an object to engage the storage system at a plurality of locations. Storage systems may also be accessible for extension or expansion.

However, existing storage systems for organization of tools and accessories for transit to a job site leave much to be desired. For instance, open volume and bag storage systems commonly used for transit can be chaotic and disorganized without intentional storage zones to hold each item in place. After transit to a “job site,” the tools and accessory organization may be expanded back out to create a usable work space. However, due to poor or non-existent organizational solutions during transit, organization at a job site may be difficult as well. Moreover, mobile organizational solutions for setting up a job site in a functional and usable work space may be insufficient to both provide easy functional access to tools and accessories while maintaining organization. For example, existing organization solutions such as stacking containers may be stacked only in a single stacking orientation. Thus, a user may not be able to arrange their storage solution in the exact direction and orientation that provides optimal accessibility.

Accordingly, improved stacking storage systems are desired in the art. In particular, stacking storage systems which provide stacking in multiple directions would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a reversible lockplate for securing a first container relative to a second container in a stacked configuration along a stacking direction is provided. The reversible lockplate includes a planar body extending between a first side and a second side, a first raised button at the first side, a second raised button at the second side, a plurality of slots configured to receive respective portions of the first container. The reversible lockplate further includes an articulation mechanism configured to rotate 180 degrees about an articulation axis and at least one biasing member. The at least one biasing member is configured to exert a biasing force on the planar body in a first direction when the reversible lockplate is in a first orientation and in a second direction when the reversible lockplate is in a second orientation. Actuation of the articulation mechanism causes the reversible lockplate to transition between the first orientation and the second orientation.

In accordance with another embodiment, a mating interface for selectively securing a first container relative to a second container in a stacked configuration along a stacking direction is provided. The mating interface a projection positioned on one of the first container and the second container, the projection being spaced apart from a surface to form a gap, the gap being open in a direction transverse to the stacking direction. The mating interface further includes a coupler moveably mounted to the other of the first container and the second container, the coupler movable between a first orientation and a second orientation and translatable in the direction transverse to the stacking direction between a first position and a second position. In the first position, a portion of the coupler is positioned within the gap thereby preventing the first container and the second container from being separated along the stacking direction. In the second position, the coupler is not positioned within the gap.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1A is a perspective view of first and second containers stacked in a first orientation in accordance with embodiments of the present disclosure;

FIG. 1B is a perspective view of first and second containers stacked in a second orientation in accordance with embodiments of the present disclosure;

FIG. 2 is partial side cross-sectional view of first and second containers stacked by a mating interface in accordance with embodiments of the present disclosure;

FIG. 3A is a perspective view of a reversible lockplate in a first orientation in accordance with embodiments of the present disclosure;

FIG. 3B is a perspective view of a reversible lockplate in a second orientation in accordance with embodiments of the present disclosure;

FIG. 4 is a top view of a storage container base in accordance with embodiments of the present disclosure;

FIG. 5 is a top view of a plate in accordance with embodiments of the present disclosure;

FIG. 6 is a top view of an articulation mechanism in accordance with embodiments of the present disclosure;

FIG. 7 is a bottom perspective view of an articulation mechanism in accordance with embodiments of the present disclosure;

FIG. 8 is a perspective view of a reversible lockplate in accordance with embodiments of the present disclosure;

FIG. 9 is a top view of an articulation mechanism of a reversible lockplate in accordance with embodiments of the present disclosure;

FIG. 10 is a perspective view of a rotational knob of an articulation mechanism in accordance with embodiments of the present disclosure;

FIG. 11 is a top view of a storage container base in accordance with embodiments of the present disclosure; and

FIG. 12 is a top view of a plate in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

When used to describe a shape, the term “generally” is used to describe an object having the overall appearance of a shape and may include slight deviations from the exact shape, such as including one or more protrusions or indentations in the outline of the shape. For example, the term “generally rectangular” may be used to describe an object having the overall appearance of a rectangle having two sets of parallel sides and four right angles, but may include one or more indentations and/or protrusions along the parallel sides and/or slight variations in the right angles at the corners. For instance, a rectangular shape having slightly rounded corners may be described as “generally rectangular” as used herein. As a further example, a “generally rhomboid” or “generally diamond” shape may have the characteristics of a rhomboid or diamond (a quadrilateral of which only the opposite sides and angles are equal) but may have additional minor (e.g., shorter) sides interposed between the equal opposite angles and sides.

Unless specified or limited otherwise, the terms “mounted,” “connected,” “supported,” and “coupled” and variations thereof are used broadly and encompass both direct and indirect mountings, connections, supports, and couplings. Additionally, unless specified or limited otherwise, the terms “lower,” “upper,” and variations thereof are used broadly for the purposes of describing relative positions of elements of the illustrated embodiments.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, the present invention is directed to a storage system having at least two stackable containers, and more specifically, a reversible lockplate for a stackable container that may enable stacking in first and second directions, e.g., opposite, directions or orientations.

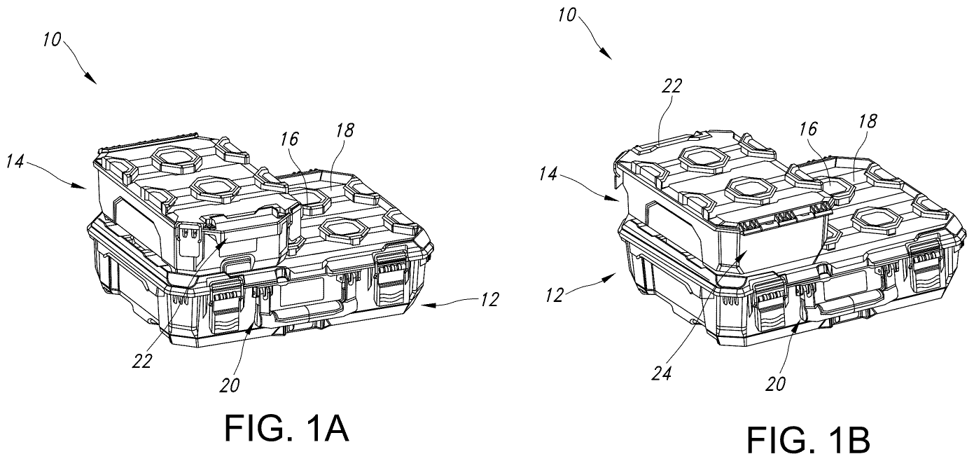

Referring now to the drawings, FIGS. 1A and 1B illustrate a storage system 10 having a first container 12 and a second container 14. The first container 12 may also be referred to as a base container, as it is the base or bottom in the stacked arrangement illustrated in FIGS. 1A-1B. The first container 12 includes a plurality of projections 16 extending upward from an upper surface 18 thereof. The first container 12 may have a front side 20. The front side 20 may include, e.g., a handle, a locking mechanism such as a latch, or other optional identifying features. The second container 14 may be stacked on top of the first container 12 in a stacking direction, e.g., a vertical direction. The second container 14 may be stacked on top of the first container 12 in a first orientation shown in FIG. 1A. In the first orientation, a front side 22 of the second container 14 may be aligned with (i.e., on a same side as) the first side 20 of the first container 12. Alternatively, the second container 14 may be stacked on top of the first container 12 in a second orientation shown in FIG. 1B. In the first orientation, a rear side 24 of the second container 14 (opposite the front side 22) may be aligned with (i.e., on a same side as) the first side 20 of the first container 12.

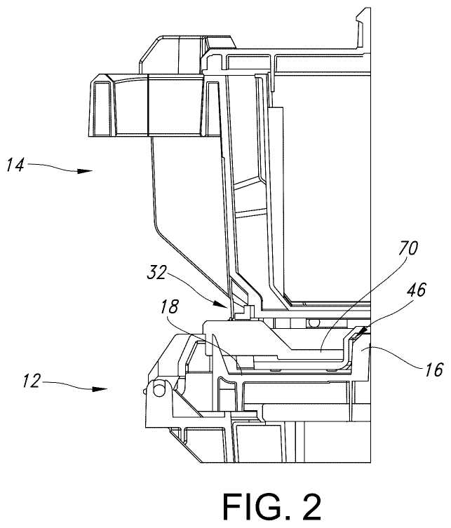

A mating interface is formed between the first container 12 and the second container 14 for selectively securing the first container 12 relative to 14 second container 14 in the stacked configuration along a stacking direction. FIG. 2 illustrates a cross-section of a portion of the mating interface.

The second container 14 includes a base assembly 30 (not visible in FIGS. 1A-1B) that forms a bottom portion of the container. Portions of the mating interface may be formed as part of the base assembly 30. The base assembly 30 includes a base 32 that may form an outermost surface of the bottom portion of the second container 14. The base assembly 30 may further include a reversible locking plate 70 coupled to the base 32.

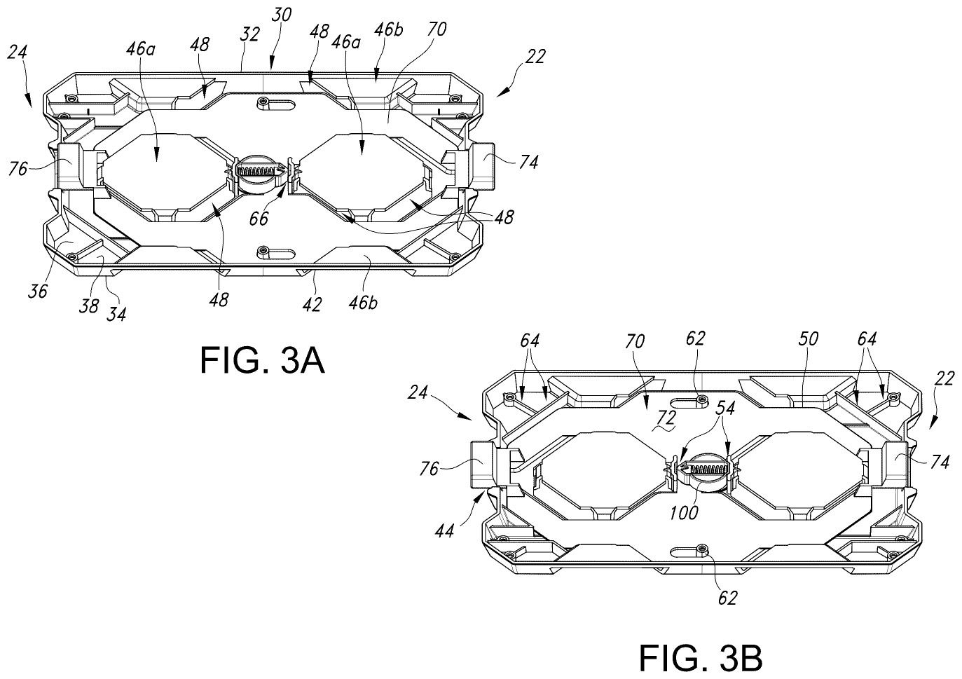

As best seen in FIGS. 2, 3A and 3B, the base 32 has an outer surface 34 facing exterior of the second container 14, and an inner surface 36 opposite the outer surface 34. A floor 38 of the base 32 may be surrounded by a sidewall 40 extending around a perimeter 42 of the base 32. The sidewall 40 may extend in a direction generally perpendicular to the floor 38. For instance, the floor 38 may be generally horizontal and the sidewall 40 may be generally vertical. In some aspects, the sidewall 40 may extend in the stacking direction. Portions of the sidewall 40 extend along the front side 22 and the rear side 24 of the container 14, respectively. Along both the front side 22 and the rear side 24, the sidewall 40 may be interrupted by a gap 44. The gaps 44 may each be disposed generally along a central portion of the first side 22 and the second side 24, respectively. As will be described in further detail, the gaps 44 may provide access for a latch or button associated with the mating interface.

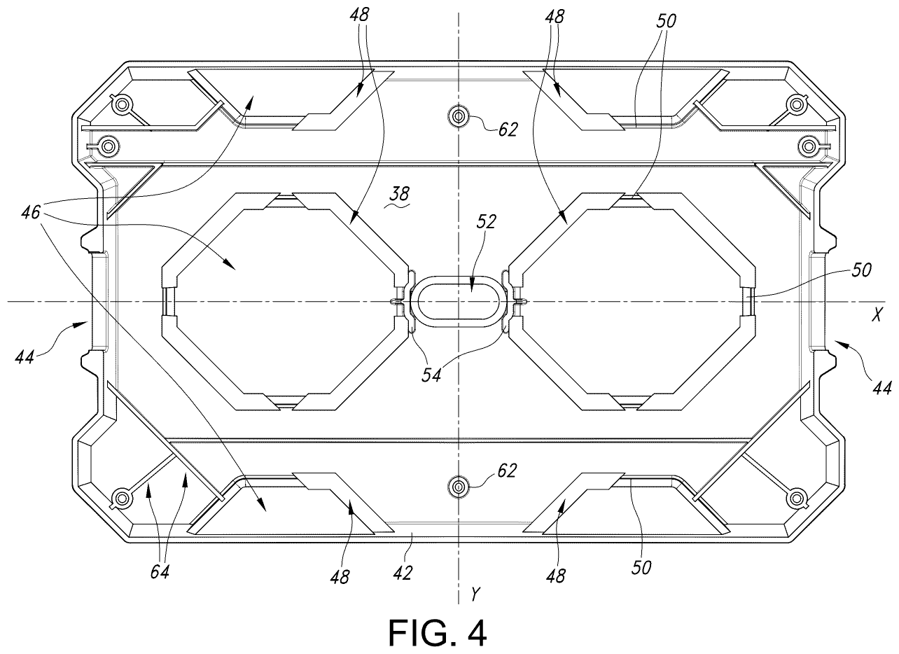

The floor 38 may include at least one cavity or depression 46. For instance, the depression(s) 46 may extend toward the interior of the second container 14. As illustrated in FIGS. 3A-3B and 4, the floor 38 may include a plurality, e.g., two, of depressions 46a having a full geometric shape, and a plurality, e.g., four, depressions 46b having a half geometric shape relative to the depressions 46a. The depressions 46a may be generally centrally located on the floor 38 and the depressions 46b may be disposed nearer to the perimeter 42, e.g., abutting the perimeter 42, of the base 32. In some aspects of the present invention, the depressions 46a and 46b may be disposed in a symmetrical arrangement. For example, the depressions 46a and 46b may be symmetrically arranged about a first axis of symmetry Y. Additionally or alternatively, the depressions 46a and 46b may be symmetrically arranged about a second axis of symmetry X.

The outer surface 34 of the floor 38 is configured to contact the upper surface of another container, e.g., upper surface 18 of the first container 12, and the at least one depression 46 is configured to receive at least one corresponding projection 16. The various complementary surfaces of the floor 38 of the second container and the top of the first container 12 form at least part of the mating interface between the adjacent containers. The various complementary surfaces of the floor 38 of the second container and the top of the first container 12 also may limit the first container 12 and second container 14 from shifting relative to one another in a direction parallel to the floor 38 while stacked. In this way, the containers are more stable when stacked and are less likely to become unstacked during use and/or transportation.

An undercut 48 may extend along a perimeter of each depression 46. At least one tab 50 may couple each depression 46 to the floor 38. In this manner, each tab may terminate a portion of the undercut 48 so at least a portion of the undercut 48 is closed along the stacking direction. For instance, each undercut 48 may extend along an entire perimeter of each depression 46 with exception of each tab 50. Each tab 50 may extend in a direction generally parallel to the sidewall 40, e.g., in the stacking direction.

As best seen in FIG. 4, an opening 52 may be formed through the floor 38 from the outer surface 34 to the inner surface 36. The opening 52 may be generally centrally located on the base 32. For instance, the opening 52 may surround a center point of the base 32. The opening 52 may be located between two depressions 46, e.g., two depressions 46a. As will be described in further detail below, the opening 52 may have an ob-round shape, i.e., having a pair of opposing elongate sides and a pair of opposing rounded ends. The opening 52 may generally extend along an axis X. The axis X may generally bisect the base assembly 32. The axis X may also extend through the depressions 46a and the gaps 44.

A guide wall 54 may be provided on either side of the opening 52 along the axis X. Each guide wall 54 may extend from the inner surface 36, e.g., in a direction generally perpendicular to the floor 38. Each guide wall 54 may have a central portion 58 through which the axis X may extend and side portions 60 offset from the central portion 58. As will be described in further detail below, the guide walls 54 may together form a detent 66 for receiving and/or guiding one or more components of the base assembly 30 relative to the base 32.

The base 32 may further include one or more guides 62 extending therefrom. For instance, a plurality of guides 62 may extend from the inner surface 36 of the base 32. The guides 62 may extend in a direction generally perpendicular to the floor 38, e.g., in a vertical direction. The guides 62 may have a generally cylindrical shape or any other suitable shape that extends perpendicular to the floor 38. The guides 62 may function to guide or limit movement of one or more components of the base assembly 30 relative to the base 32.

The base 32 may further include one or more ribs 64 extending upward from the inner surface 36. The rib(s) 64 may function as a support structure for the base 32 to maintain its shape and strength. For instance, the base 32 may be molded as a single piece, and it is customary to provide one or more ribs to add strength and support in a molded structure. Moreover, the rib(s) 64 may form stop surfaces to guide or limit movement of one or more components of the base assembly 30 relative to the base 32.

The base assembly 30 further includes a plate 70. The plate 70 may also be referred to as a reversible locking plate or a coupler, as the plate 70 may function to couple the stacked containers together in a stacking arrangement to prevent the first container and the second container from being separated along the stacking direction. The plate 70 includes a planar body 72. The plate 70 further includes a first raised button 74 and a second raised button 76. The first raised button 74 and the second raised button 76 may each extend from the planar body 72. For instance, the first raised button and the second raised button 76 may extend from the planar body 72 in a generally vertical direction. Additionally, the first raised button and the second raised button 76 may each extend from the planar body 72 in a generally lateral direction, e.g., along the axis X. The first raised button and the second raised button 76 may be shaped and sized to extend through the respective gaps 44 of the sidewall 40 of the base 32 when the plate 70 is operably coupled with the base assembly 30.

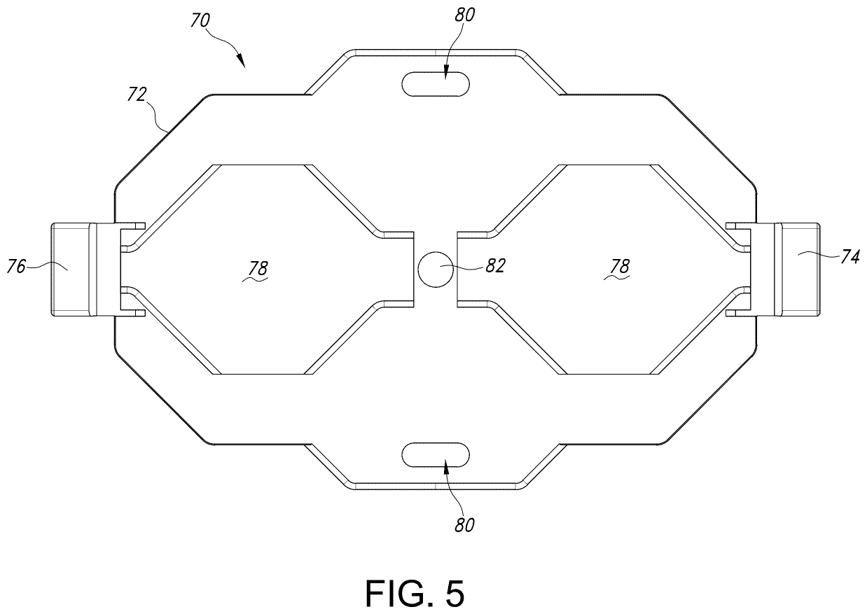

The planar body 72 of the plate 70 may have a plurality of apertures extending therethrough. For instance, a plurality of apertures may be provided to enable portions of the base assembly 32 to extend through the planar body 72. The planar body 72 may have one or more polygonal openings 78 configured to receive a depression 46 of the base 30 therethrough. As illustrated in FIGS. 3A, 3B and 5, the planar body 72 may have two polygonal openings 78 to receive two respective projections 38a therethrough. Additionally, the planar body 72 may have a plurality of guide openings 80 each configured to receive a respective one of the guides 62 therethrough. The guide openings 80 may each form a slot that is elongated in a direction parallel to the axis X, e.g., to allow relative movement between the plate 70 and the guides 62 along a direction parallel to the axis X. A center hole 82 may extend through the planar body 72, e.g., around a center point of the planar body 72. The center hole 82 may be disposed between the polygonal openings 78. The center hole 82 may be aligned with the axis X.

As illustrated in FIGS. 3A-3B, when the base assembly 30 and the plate 70 are operably coupled, e.g., with the plate 70 resting on the inner surface 36 of the base 32, the plate 70 may be movable relative to the base 32 in a direction parallel to the axis X. For instance, the plate 70 may be translatable along the axis X. The axis X may be transverse to a stacking direction of the containers 12 and 14.

The reversible locking plate 70 further includes an articulation mechanism 100. The articulation mechanism 100 may include a biasing member 102, e.g., a spring. The biasing member 102 may impose a biasing force on the plate 70 toward a first position. The first position may be an engaged position, i.e., in which the locking plate 70 is engaged in a locking manner when the storage containers 12, 14 are stacked. In some embodiments, the biasing force exerted by the biasing member 102 biases the locking plate 70 toward the first position, regardless of whether storage containers 12, 14 are stacked relative to one another.

The plate 70 may be movable (e.g., slidable or translatable) from the first position, against a biasing force exerted by the biasing member 102, into a second position. The second position may be a disengaged position, e.g., in which the locking function of the locking plate 70 is disengaged during a stacking or unstacking operation of the storage containers 12, 14. For instance, the first button 74 and/or the second button 76 may be moved, e.g., pushed, in a direction against the biasing force to move the locking plate 70 from the first position to the second position. When the plate 70 is moved between the first position and the second position, each guide opening 80 may translate along a respective guide 62.

FIG. 3A illustrates the locking plate 70 in the first position and arranged in a first orientation. In the first orientation, the biasing member 102 may be oriented such that biasing force on the locking plate 70 causes the first button 74 of the locking plate 70 to extend from the gap 44 along the front side 22 in the first position. The first button 74 may be activated to move the locking plate 70 toward the second position from the first position.

FIG. 3B illustrates the locking plate 70 in the first position and arranged in a second orientation. In the second orientation, the biasing member 102 may be oriented such that biasing force on the locking plate 70 causes the second button 76 of the locking plate 70 to extend from the gap 44 along the rear side 24 in the first position. The second button 76 may be activated to move the locking plate 70 toward the second position from the first position. Thus, the second orientation may be described as a “reversed” orientation relative to the first orientation.

The articulation mechanism 100 may be configured to rotate relative to the planar body 72. Rotation of the articulation mechanism 100 may cause the locking plate 70 to transition between the first orientation (FIG. 3A) and the second orientation (FIG. 3B).

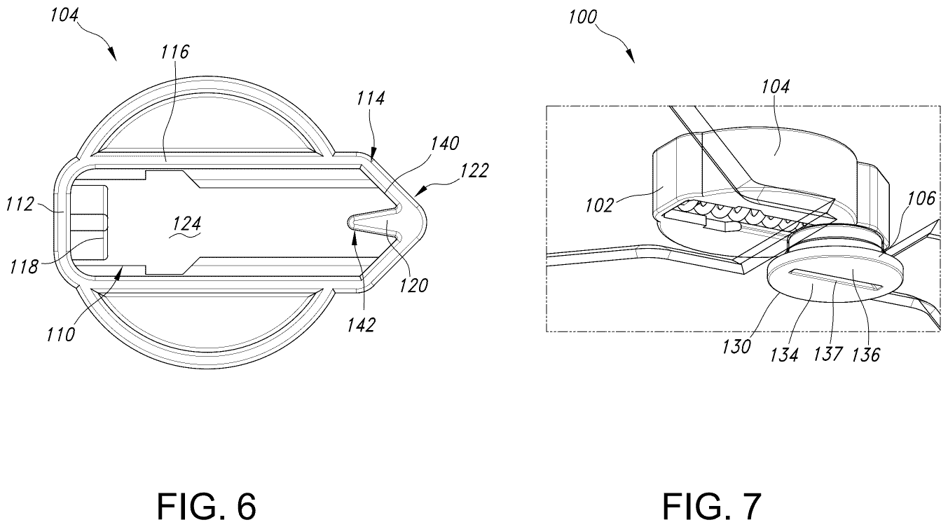

FIG. 6 illustrates a top view of the articulation mechanism 100 omitting the biasing member 102. The articulation mechanism 100 includes a biasing member housing 104 and a rotation member 106. The biasing member housing 104 may have a generally circular or rounded body 108 and a biasing member track 110. The biasing member track 110 may extend through the rounded body 108 and may, for instance, protrude from sides of the rounded body 108 on one or both sides of the track 110. The track 110 may extend between a first end 112 and a second end 114 and may be configured to receive the biasing member 102 between the first end 112 and second end 114. The track 110 may be surrounded by a sidewall 116 configured to limit movement and/or placement of the biasing member 102. A biasing member receiver 118 may be provided, e.g., at an inner side of the sidewall 116. For instance, the biasing member receiver 118 may be provided at one end of the track 110 along the direction of the axis X.

The biasing member housing 104 may include an alignment feature 120. The alignment feature 120 may be provided, e.g., at an inner side of the sidewall 116 of the track 110. For instance, the alignment feature 120 may be disposed at an opposite end of the track 110. The alignment feature 120 may be configured to align with the rotation member 106, e.g., via complementary engagement. Optionally, as illustrated in FIG. 6, the biasing member track 110 may have a directional shape 122 at an end thereof that is configured to indicate a direction of the biasing member 102 to a user. The directional shape 122 may be, e.g., an arrow shape, triangular shape, V-shape, or any other suitable shape that may indicate a direction to a user. The alignment feature 120 may be disposed at a same end of the track 110 as the directional shape 122. In this regard, a user may be able to determine if the locking plate 70 is in the first orientation or the second orientation based on the directional shape of the biasing member track 110.

As illustrated in FIG. 6, the biasing member housing 104 may include an elongated opening 124 therethrough. The elongated opening 124 may extend generally within the biasing member track 110. For instance, the elongated opening 124 may have an elongated dimension extending generally parallel to the axis X. In some aspects of the invention, the elongated opening 124 may form a translation channel to allow relative translational movement between at least a portion of the articulation mechanism 100, the base 30, and the plate 70.

The rotation member 106 may have a rotational piece 130 configured to control rotation of the rotation member 106 and an alignment body 132 configured to be operably coupled with the biasing member housing 104. The rotational piece 130 may include an actuator 134 configured to be actuated by a user. For instance, the actuator 134 may include a gripping piece 136 configured to be gripped by a user's fingers and/or a tool such as pliers to rotate the rotational piece 130. The actuator 134 may optionally further include a groove 137, e.g., along the gripping piece 136 or distinct from the gripping piece 136, configured to receive a tool therein to cause rotation of the rotational piece 130. The rotational piece 130 may be rotatable about 180 degrees in a clockwise or counter-clockwise direction. In some aspects of the invention, the rotational piece 130 may be rotatable about 360 degrees in a clockwise or counter-clockwise direction. Optionally, the rotational piece 130 may be rotatable about 360 degrees in both the clockwise and counter-clockwise directions.

The alignment body 132 of the rotation member 106 is configured to extend from the rotational piece 130, e.g., in a generally vertical direction. In this manner, the alignment body 132 may be configured to extend into the biasing member track 110. At least a portion of a perimeter of the alignment body 132 may be configured to align with and/or contact the sidewall 116 of the track 110. The alignment body 132 may have a first side 138 configured to contact the biasing member 102 and a second side 140 configured to contact the alignment member 120 of the biasing member housing 104. For instance, the second side 140 may have a receiver 142 configured to receive the alignment member 120. As illustrated in FIG. 6, the receiver 142 may have a complementary shape to the alignment member 120.

The biasing member 102, e.g., coil spring, may be disposed within the biasing member track 110. For instance, a first end of the biasing member 102 may be held in place relative to the biasing member receiver 118. The biasing member receiver 118 may be inserted into the biasing member 102 to hold the biasing member 102 in place against the sidewall 116. At an opposite end of the track, the biasing member 102 may contact the first side 138 of the alignment body 132. The biasing member 102 may be compressed (e.g., in a direction opposite a biasing direction) to fit within the track 110. The biasing member 102 may be held in place between the sidewall 116, biasing member receiver 118 and the first side 138 of the alignment body 132, e.g., by a biasing force exerted by the biasing member 102.

When the reversible locking plate 70 is assembled with the base assembly 30, the rotational piece 130 is configured to be disposed along the outer surface 34 of the base 32. The rotational piece 130 may be disposed along an outer side of the opening 52 of the base 32. In this regard, a user may access the actuator 134 when the container 14 is assembled. When the planar body 72 is moved, e.g., translated, along a direction of the axis X, the rotational piece 130 may be moved in the translation direction relative to the base 32.

When the reversible locking plate 70 is assembled, the alignment body 132 of the rotation member 106 may extend through the opening 52 of the base 32 and the center hole 82 of the planar body 72. The alignment body 132 may rotate within the center hole 82. However, the alignment body 132 is generally unable to move in any lateral direction within the center hole 82. When the planar body 72 is moved, e.g., translated, along a direction of the axis X, the alignment body 132 may be moved in the translation direction. Thus, when the planar body 72 is moved, e.g., translated, along a direction of the axis X, the alignment body 132 may move within the elongated opening 124 of the biasing member housing 104 along the axis X. Similarly, when the planar body 72 is moved, e.g., translated, along a direction of the axis X, the articulation mechanism 100 may be moved, e.g., translated, along the direction of the axis X within the opening 52 of the base 32.

In further aspects of the present invention, instead of the articulation mechanism 100 being arranged generally centrally relative to the base 32 and locking plate 70, an articulation mechanism 200 may be provided off-center, e.g., off-center relative to the first and second raised buttons 74 and 76. Additionally or alternatively, the articulation mechanism 200 may be accessible from an interior of the storage container, as described in further detail below. The base and the locking plate made be modified compared to those described with regard to FIGS. 3A-3B and 4 to accommodate modifications to the articulation mechanism 200.

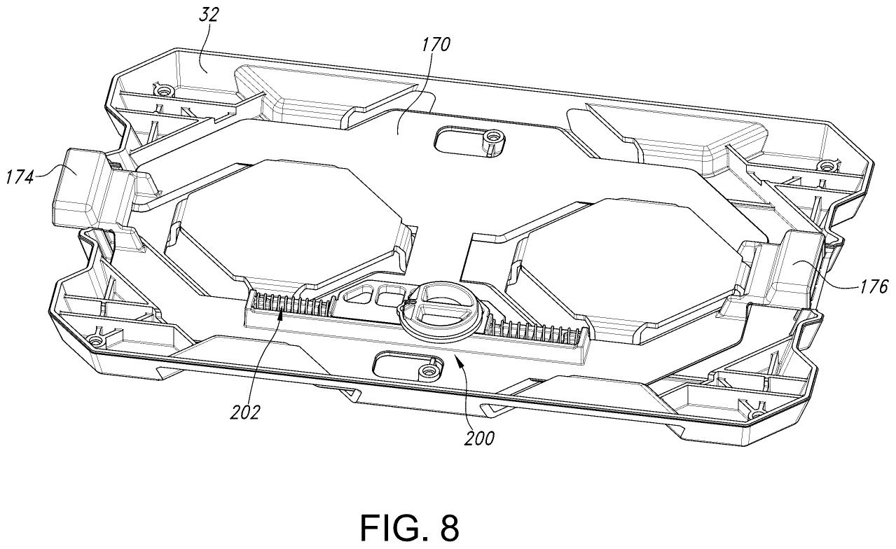

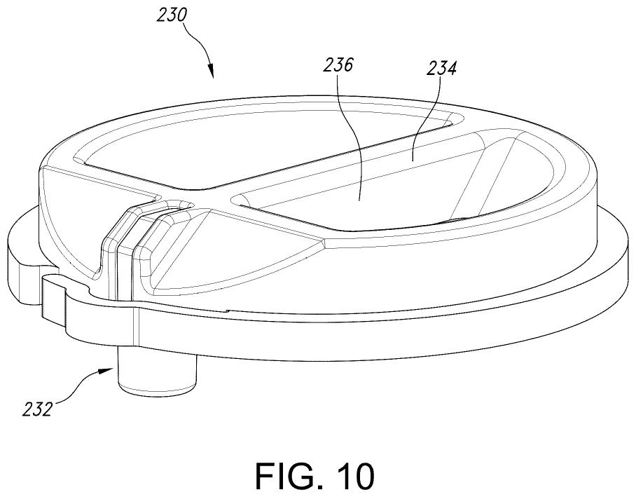

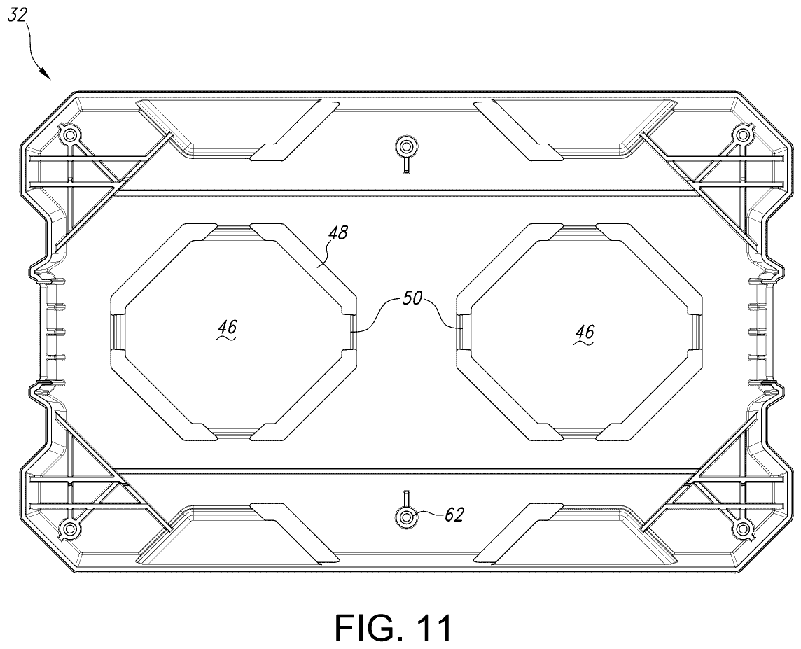

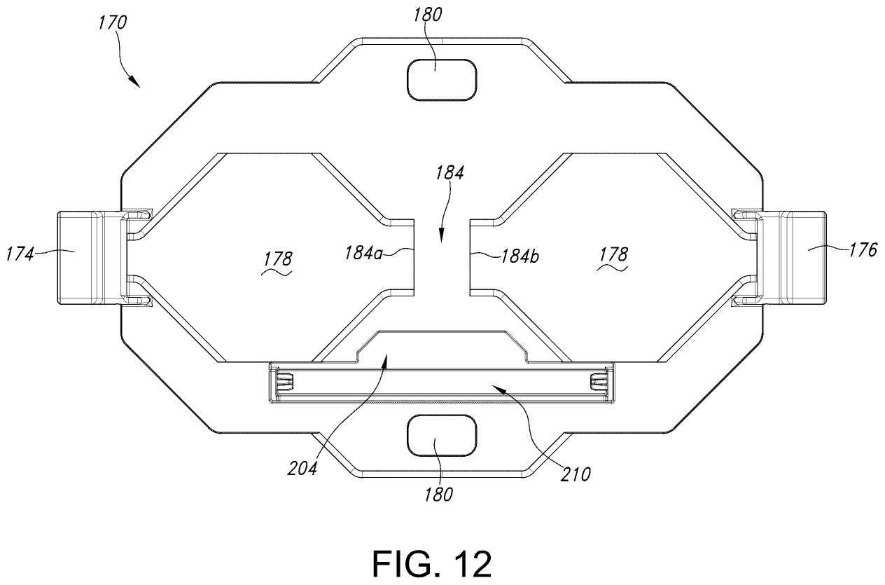

In the arrangement illustrated in FIGS. 8-12, the base 32 may be generally the same as described with regard to FIGS. 3A-3B and 4 above, except that the base 32 may not include an opening 52 between the depressions 46. Instead, a user may access the articulation mechanism 200 from within the storage container, e.g., above the locking plate 70, such that the opening 52 is not required to be provided through the base 32 for the articulation mechanism 200 to extend through.

A locking plate 170 may be provided with the base 32. The locking plate 170 may be generally similar to the locking plate 70, but instead of receiving an articulation mechanism between its polygonal openings, the articulation mechanism 200 may be received toward a perimeter of the locking plate 170 and spaced away from the axis X. Nevertheless, the locking plate 170 includes substantially identically shaped polygonal openings 178, guide openings 180 spaced away from the axis X, and a first button 174 and a second button 176 disposed along the axis X. The locking plate 170 may further include a central portion 184 between the polygonal openings 178 having edges 184a and 184b along the polygonal openings 178, respectively. The edges 184a and 184b may be disposed generally perpendicular to the axis X and may be configured to abut against the tabs 50 of the depressions 48 of the base 32 to limit translation of the locking plate 170 along the direction of the axis X. In other words, the edges 184a and 184b limit the translative range of motion of the locking plate 170 when installed on the base 32. The locking plate 170 further includes a housing 204 associated with the articulation mechanism 200, as described below.

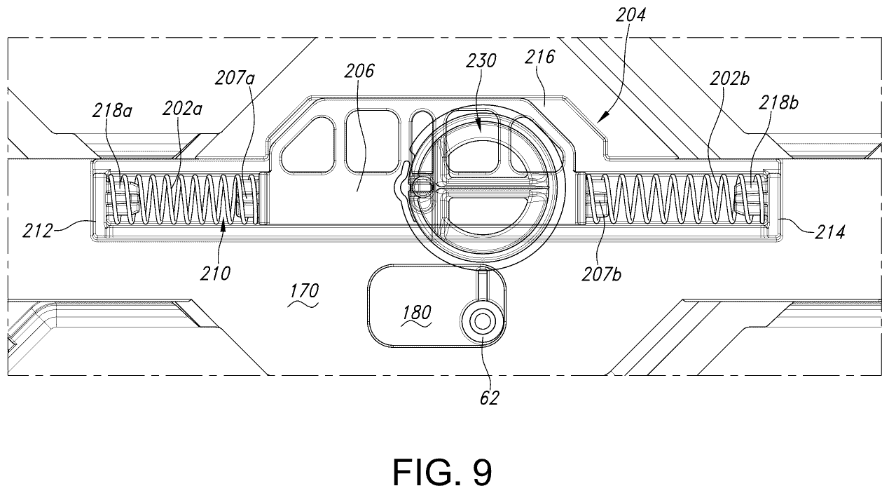

The articulation mechanism 200 includes at least one biasing member 202 configured to be situated within the biasing member housing 204 of the locking plate 170. As shown in FIGS. 8 and 9, there may be a first biasing member 202a and a second biasing member 202b disposed at either end of the articulation mechanism 200 parallel the axis X. The articulation mechanism 200 includes a biasing member housing 204 and a translation member 206. The biasing member housing 204 may have a generally polygonal body 208 having a similar shape as the translation member 206, and a biasing member track 210. The biasing member track 210 may extend through or along at least one side of the body 208 and may, for instance, protrude from sides of the body 208 on one or both sides of the track 210. The track 210 may extend between a first end 212 and a second end 214 and may be configured to receive the biasing members 202 between the first end 212 and second end 214. For instance, the first biasing member 202a may be received at the first end 212 and the second biasing member 202b may be received at the second end 214. The track 210 may be surrounded by a sidewall 216 configured to limit movement and/or placement of the biasing members 202. At least one biasing member receiver 218 may be provided, e.g., at an inner side of the sidewall 216. For instance, a biasing member receiver 218 may be provided at each end of the track 210 along a direction parallel to axis X.

The biasing member housing 204 may include an alignment feature 220. The alignment feature 220 may be provided, e.g., at an inner side of the sidewall 216 of the track 210. The alignment feature 220 may be a complementary shape, e.g., angled shape, common between the translation member 206 and the biasing member housing 204. For instance, as illustrated in FIGS. 8 and 9, both the biasing member housing 204 and the translation member 206 include a polygonal-shaped protruding portion having an edge parallel to a direction of translation, edges perpendicular to the direction of translation and extending from the track 210, and first and second angled edges extending between the respectively perpendicular sides. In this manner, translative movement of the translation member 206 within the biasing member housing 204 is limited.

The translation member 206 may have a biasing member receiver 207. For instance, a first biasing member receiver 207a may be configured to receive the first biasing member 202a, and a second biasing member receiver 207b may be configured to receive the second biasing member 202b. In this manner, each biasing member 202 may be securely received between an end of the track 210 and the translation member 206.

The articulation mechanism 200 includes a rotational piece 230 (sometimes referred to as a knob) configured to cause translation of the translation member 206 within the housing 204. The rotational piece 230 may include a peg 232 extending therefrom that is configured to be received by the translation member 206. The rotational piece 230 may include an actuator 234 configured to be actuated by a user. For instance, the actuator 234 may include a gripping piece 236 configured to be gripped by a user's fingers and/or a tool such as pliers to rotate the rotational piece 230. The actuator 234 may optionally further include a groove, e.g., along the gripping piece 236 or distinct from the gripping piece 236, configured to receive a tool therein to cause rotation of the rotational piece 230.

The rotational piece 230 may be rotatable about 180 degrees in a clockwise or counter-clockwise direction. Rotation of the rotational piece 230 may drive the translation member 206 via the peg 232 to be biased to one side, e.g., the first end 212 or the second end 214 of the track 210. For instance, the knob 230 can be rotated 180 degrees clockwise, driving the translation member 206 to be biased to the second end 214 of the track 210, compressing the second biasing member 202b slightly more than the first biasing member 202a and translating the locking plate 170 toward the right side. From that position, the knob 230 can be rotated 180 degrees counterclockwise to translate the locking plate 170 back towards the left (by biasing to the first end 212 of the track 210 and compressing the first biasing member 202a slightly more than the second biasing member 202b). The locking plate 170 translates to the right or left at the same rate as the translation member 206 when the knob 230 is rotated. The biasing members 202a and 202b maintain the translation member 206 at an equilibrium point between the first end 212 and second end 214. The equilibrium point is slightly right or left of center, i.e., slightly more towards the first end 212 or second end 214, based on the position of the locking plate 170.

When the reversible locking plate 170 is assembled with the base assembly 30, the knob 230 may be configured to be disposed at an inner side of the base 32. In this regard, a user may access the actuator 234 from within the container 14 when the container 14 is assembled. When the planar body 172 is moved, e.g., translated, along a direction of the axis X, the rotational piece 230 may be moved in the translation direction relative to the base 32. However, the present inventors further contemplate additional aspects of the present invention incorporating the features of the rotational piece 130 illustrated in FIG. 6 which extends on an outer side of the base assembly 30 with the off-center articulation mechanism 200 described herein.

Further aspects of the invention are provided by one or more of the following embodiments:

A reversible lockplate for securing a first container relative to a second container in a stacked configuration along a stacking direction, the reversible lockplate comprising: a planar body extending between a first side and a second side, a first raised button at the first side, a second raised button at the second side, a plurality of slots configured to receive respective portions of the first container; an articulation mechanism configured to rotate 180 degrees about an articulation axis; and a biasing member, the biasing member configured to exert a biasing force on the planar body in a first direction when the reversible lockplate is in a first orientation and in a second direction when the reversible lockplate is in a second orientation, wherein actuation of the articulation mechanism causes the reversible lockplate to transition between the first orientation and the second orientation.

The reversible lockplate of any one or more of the embodiments, wherein the planar body is symmetrical about a first axis of symmetry.

The reversible lockplate of any one or more of the embodiments, wherein the first axis of symmetry extends through the first raised button and the second raised button.

The reversible lockplate of any one or more of the embodiments, wherein the planar body is symmetrical about a second axis of symmetry different from the first axis of symmetry.

The reversible lockplate of any one or more of the embodiments, wherein the planar body, the first raised button, and the second raised button are formed as one piece.

The reversible lockplate of any one or more of the embodiments, wherein the articulation mechanism comprises a rotational piece configured to control rotation of the articulation mechanism, the rotational piece extending through an articulation aperture in the planar body.

The reversible lockplate of any one or more of the embodiments, the articulation mechanism comprising a biasing member housing, the biasing member housing being translatable relative to the rotational piece along a first axis to allow for compression and extension of the biasing member.

The reversible lockplate of any one or more of the embodiments, wherein a biasing member coupling of the rotational piece extends within a translation channel of the biasing member housing, wherein translation of the biasing member coupling in the first direction causes compression of the biasing member.

The reversible lockplate of any one or more of the embodiments, wherein movement of the planar body in the first direction causes compression of the biasing member.

The reversible lockplate of any one or more of the embodiments, wherein translation of one of the first raised button and the second raised button along a first axis causes translation of the planar body along the first axis.

The reversible lockplate of any one or more of the embodiments, wherein the articulation mechanism is configured to rotate 360 degrees about the articulation axis, optionally wherein the articulation mechanism is configured to rotate 360 degrees about the articulation axis in a clockwise and counter-clockwise direction.

A mating interface for selectively securing a first container relative to a second container in a stacked configuration along a stacking direction, the interface comprising: a projection positioned on one of the first container and the second container, the projection being spaced apart from a surface to form a gap, the gap being open in a direction transverse to the stacking direction; and a coupler moveably mounted to the other of the first container and the second container, the coupler movable between a first orientation and a second orientation and translatable in the direction transverse to the stacking direction between a first position and a second position, in the first position, a portion of the coupler is positioned within the gap thereby preventing the first container and the second container from being separated along the stacking direction, and in the second position, the coupler is not positioned within the gap.

The mating interface of any one or more of the embodiments, comprising an articulation mechanism rotatable 180 degrees about an articulation axis, wherein rotation of the articulation mechanism causes movement of the coupler between the first orientation and the second orientation.

The mating interface of any one or more of the embodiments, wherein the coupler is biased toward the first position by a biasing member.

The mating interface of any one or more of the embodiments, wherein a tab terminates a portion of the gap such that a portion of the gap is closed along the stacking direction, and wherein the coupler is configured to engage and overlap the tab with respect to the stacking direction while in the first position.

The mating interface of any one or more of the embodiments, wherein the coupler translates in the direction transverse to the stacking direction as the first container is brought closer to the second container along the stacking direction, and wherein the coupler is urged by a biasing force to the first position once the coupler passes beyond the tab along with respect to the stacking direction.

The mating interface of any one or more of the embodiments, wherein in the first orientation, the coupler is biased toward a first side in the first position, and in the second orientation, the coupler is biased toward a second side in the first position.

The mating interface of any one or more of the embodiments, wherein in the first orientation, the coupler is biased toward the second side in the second position, and in the second orientation, the coupler is biased toward the first side in the second position.

An apparatus as shown and described in one or more embodiments herein.

A system configured to operate in accordance with any one or more of the embodiments disclosed herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A reversible lockplate for securing a first container relative to a second container in a stacked configuration along a stacking direction, the reversible lockplate comprising:
a planar body extending between a first side and a second side, a first raised button at the first side, a second raised button at the second side, a plurality of slots configured to receive respective portions of the first container;
an articulation mechanism configured to rotate 180 degrees about an articulation axis; and
at least one biasing member, the biasing member configured to exert a biasing force on the planar body in a first direction when the reversible lockplate is in a first orientation and in a second direction when the reversible lockplate is in a second orientation,
wherein actuation of the articulation mechanism causes the reversible lockplate to transition between the first orientation and the second orientation.

2. The reversible lockplate of claim 1, wherein the planar body is symmetrical about a first axis of symmetry,

3. The reversible lockplate of claim 2, wherein the first axis of symmetry extends through the first raised button and the second raised button.

4. The reversible lockplate of claim 2, wherein the planar body is symmetrical about a second axis of symmetry different from the first axis of symmetry.

5. The reversible lockplate of claim 1, wherein the planar body, the first raised button, and the second raised button are formed as one piece.

6. The reversible lockplate of claim 1, wherein the articulation mechanism comprises a rotational piece configured to control rotation of the articulation mechanism.

7. The reversible lockplate of claim 6, the articulation mechanism comprising a biasing member housing, the biasing member housing being translatable relative to the rotational piece along a first axis to allow for compression and extension of the at least one biasing member.

8. The reversible lockplate of claim 6, wherein a biasing member coupling of the rotational piece extends within a translation channel of the biasing member housing, wherein translation of the biasing member coupling in the first direction causes compression of the at least one biasing member.

9. The reversible lockplate of claim 6, wherein movement of the planar body in the first direction causes compression of the at least one biasing member.

10. The reversible lockplate of claim 6, wherein translation of one of the first raised button and the second raised button along a first axis causes translation of the planar body along the first axis.

11. The reversible lockplate of claim 1, wherein the articulation mechanism is configured to rotate 360 degrees about the articulation axis, optionally wherein the articulation mechanism is configured to rotate 360 degrees about the articulation axis in a clockwise and counter-clockwise direction.

12. A mating interface for selectively securing a first container relative to a second container in a stacked configuration along a stacking direction, the interface comprising:
a projection positioned on one of the first container and the second container, the projection being spaced apart from a surface to form a gap, the gap being open in a direction transverse to the stacking direction; and
a coupler moveably mounted to the other of the first container and the second container, the coupler movable between a first orientation and a second orientation and translatable in the direction transverse to the stacking direction between a first position and a second position,
in the first position, a portion of the coupler is positioned within the gap thereby preventing the first container and the second container from being separated along the stacking direction, and
in the second position, the coupler is not positioned within the gap.

13. The mating interface of claim 12, comprising an articulation mechanism rotatable 180 degrees about an articulation axis, wherein rotation of the articulation mechanism causes movement of the coupler between the first orientation and the second orientation.

14. The mating interface of claim 12, wherein the coupler is biased toward the first position by at least one biasing member.

15. The mating interface of claim 12, wherein a tab terminates a portion of the gap such that a portion of the gap is closed along the stacking direction, and wherein the coupler is configured to engage and overlap the tab with respect to the stacking direction while in the first position.

16. The mating interface of claim 15, wherein the coupler translates in the direction transverse to the stacking direction as the first container is brought closer to the second container along the stacking direction, and wherein the coupler is urged by a biasing force to the first position once the coupler passes beyond the tab along with respect to the stacking direction.

17. The mating interface of claim 12, wherein in the first orientation, the coupler is biased toward a first side in the first position, and in the second orientation, the coupler is biased toward a second side in the first position.

18. The mating interface of claim 17, wherein in the first orientation, the coupler is biased toward the second side in the second position, and in the second orientation, the coupler is biased toward the first side in the second position.
